(19) United States
(12) Patent Application Publication
(10) Pub. No.: US 2015/0188858 A1
(43) Pub. Date: Jul. 2, 2015

(54) COMMUNICATION METHOD, COMMUNICATION APPARATUS, AND PROGRAM

(71) Applicant: DeNA CO., Ltd., Tokyo (JP)

(72) Inventors: Ichito Nagata, Tokyo (JP); Hiroki Yoshifuji, Tokyo (JP)

(21) Appl. No.: 14/408,707

(22) PCT Filed: May 30, 2013
(86) PCT No.: PCT/JP2013/065018

§ 371 Date: Dec. 17, 2014

(30) Foreign Application Priority Data
Jun. 21, 2012 (JP) 2012-140274

(51) Int. Cl. H04L 12/58; H04L 29/08; G06F 17/30

(52) U.S. Cl. CPC H04L 51/046; G06F 17/30864; H04L 67/10

(57) ABSTRACT

When a chat service initiation request arrives from a user terminal, the most suitable communication modality is determined based on registration information stored in memory and the message transmitted from the user terminal is converted to this communication modality and then transmitted to the remote party. In principle, if the destination party is a registered member, the chat modality is selected as the communication modality employed when communicating with the remote destination party. On the other hand, if the destination party is an unregistered member, a modality is selected that corresponds to the information registered in memory in association with the unregistered member.

### TECHNICAL FIELD

The present invention relates to technology for the transmission and reception of messages with the help of information processing terminals.

### BACKGROUND ART

Heretofore, services referred to as “chat” have been provided for real-time text communication with the help of information processing devices such as PC (Personal Computer) terminals, mobile terminals, and the like.

However, in the case of a conventional chat service, even if a user wanted to chat with a non-member who was not subscribed to or registered with the chat service, it was impossible to chat unless the member was registered with the chat service. For this reason, the non-member had to be sent a separate e-mail, or the like, resulting in potentially laborious operations.

In connection with such problems, Patent Document 1 has disclosed a method for multi-modal communication in which a first interface converts a modality such as e-mail, chat and the like into a different modality and provides it to a second interface via a computer network.

### PRIOR ART DOCUMENTS

### Patent Documents

Patent Document 1: Published Japanese Translation of PCT International Application No. 2011-525676.

### SUMMARY OF THE INVENTION

### Problems to be Solved by the Invention

However, in the prior art, when a member of a chat service sent a message to a non-member for the first time, the non-member's e-mail address and other information had to be meticulously registered, which required laborious operations and created a high “barrier” to overcome before one could start using the chat service. Furthermore, there was other room for improvement, e.g. when users transmitted messages, the users had to select the communication modality by themselves.

The present invention has been devised by taking such problems into consideration, and it is an object of the invention to provide a communication method, a communication apparatus, and a software program that alleviate the burden on the user by enabling a seamless exchange of messages even in the case of chat with non-users.

### Means for Solving the Problems

One aspect of the present invention relates to a communication method. This communication method is a method used for the transmission and reception of messages with the help of information processing terminals and includes the steps of: receiving a destination and a message to be transmitted to said destination; selecting one communication modality from one or more communication modalities registered in memory in association with the received destination based on information indicating the order of priority of the communication modalities to be employed; and transmitting the message to the destination using the selected communication modality.

In accordance with this aspect, the communication modality is automatically configured by selecting one communication modality from among one or more communication modalities registered in memory in association with a received destination based on information indicating the order of priority of the communication modalities to be employed, thereby alleviating the burden on the user when sending messages to unregistered members.

In addition, this communication method may include the steps of: acquiring one or more pieces of contact information stored in an information processing terminal; matching the acquired contact information with registered contact information; and combining the acquired contact information with the registered contact information if, as a result of matching, it is found that common information is contained in the two pieces of contact information.

In accordance with this aspect, the burden on the user at the time when the use of the service is initiated can be alleviated by combining the acquired contact information with the registered contact information if, as a result of matching the acquired contact information with the registered contact information, it is found that common information is contained in the two pieces of contact information.

In addition, this communication method may include the steps of: upon receiving a message based on a communication modality other than chat, converting said message to a message in chat format; and displaying the converted message on a chat interface.

In accordance with this aspect, converting to a message in chat format and displaying on a chat interface makes it possible to exchange messages as if the parties were engaged in chat because the messages can be displayed on the same chat screen even when exchanging messages with an unregistered member.

Further, this communication method may include the steps of: allowing a user to select one or more messages displayed on a chat interface; attaching flags to the selected messages and managing them as messages selected by the user; in response to an instruction from the user, using the flags to extract one or more messages selected by the user in the past; and exporting the extracted messages to a web page and allowing a predetermined user to view them.

In accordance with this aspect, using flags to extract one or more messages selected by the user in the past and exporting them to a web page (updating a web page) facilitates extensive sharing of message exchanges during chat.

In addition, this communication method may include the steps of: creating event information obtained by respectively combining one or more time candidates with one or more location candidates; and posing a query as to possible attendance of the event associated with the created event information. In this case, as far as the selection step is concerned, URL information used to receive responses regarding possible attendance from users is included in the message to be transmitted if a communication modality other than chat was selected when the query about possible attendance of the event was posed.

In accordance with this aspect, including URL information used to receive responses regarding possible attendance from users in the message to be transmitted makes it possible to readily pose queries about attending events even to unregistered users.

Another aspect of the present invention is a program. This program is a program used by a service performing the transmission and reception of messages with the help of information processing terminals and directs a computer to carry out processing including the steps of: receiving a destination and a message to be transmitted to said destination; selecting one communication modality from one or more communication modalities registered in memory in association with the received destination based on information indicating the order of priority of the communication modalities to be employed; and transmitting the message to the destination using the selected communication modality.

Yet another aspect of the present invention is a communication apparatus. This communication apparatus is a communication apparatus used by a service performing the transmission and reception of messages with the help of information processing terminals, and is provided with: a reception unit receiving a destination and a message to be transmitted to said destination; a selection unit selecting one communication modality from one or more communication modalities registered in memory in association with the received destination based on information indicating the order of priority of the communication modalities to be employed; and a transmitter unit transmitting the message to the destination using the selected communication modality.

It should be noted that discretionary combinations of the constituent elements above, as well as the results of converting the wording of the present invention into methods, apparatus, systems, computer programs, and the like, are valid aspects of the present invention.

### Effects of the Invention

In accordance with the present invention, the burden on the user can be alleviated by enabling a seamless exchange of messages even in the case of chat with non-users.

### BRIEF DESCRIPTION OF THE DRAWINGS

FIG. 1 A diagram illustrating a chat system according to Working Example 1.

FIG. 2 A diagram illustrating an exemplary server configuration in the chat system of FIG. 1.

FIG. 3 A diagram illustrating an exemplary chat control unit configuration in the server of FIG. 2.

FIG. 4 A diagram illustrating an exemplary configuration of the mobile terminals or PC terminal of FIG. 1.

FIG. 5 A flow chart illustrating a first processing procedure of the chat control unit of FIG. 3.

FIG. 6 A flow chart illustrating a second processing procedure of the chat control unit of FIG. 3.

FIG. 7 A diagram illustrating an exemplary chat control unit configuration according to Working Example 2.

FIG. 8 A sequence diagram illustrating an exemplary processing procedure relating to message management by the server and user terminals according to Working Example 2.

FIG. 9 A diagram illustrating an exemplary configuration of the chat control unit according to Working Example 3.

FIG. 10 A diagram illustrating an exemplary transition on a chat interface screen according to Working Example 3.

FIG. 11 A diagram illustrating an exemplary display on the Event Screen G1 of FIG. 10.

FIG. 12 A diagram illustrating an exemplary display on the Event Creation Screen G3 of FIG. 10.

FIG. 13 A diagram illustrating a first exemplary display on the Chat Screen G4 of FIG. 10.

FIG. 14 A diagram illustrating an exemplary display on the Event Details Screen G5 of FIG. 10.

FIG. 15 A diagram illustrating a second exemplary display on the Chat Screen G4 of FIG. 10.

FIG. 16 A diagram illustrating an exemplary display on the Event Response Confirmation Screen G6 of FIG. 10.

### BEST MODE FOR CARRYING OUT THE INVENTION

First of all, prior to describing the aspects of the present invention, a summary of the present invention will be provided. The present invention relates to a chat service used to transmit and receive messages between information communication terminal devices. When messages are exchanged using the chat service, members registered with the chat service (hereinafter referred to as “registered members”) can engage in chat with partners without being aware of whether or not their partners are registered with the chat service.

Conventionally, when engaging in chat with members not registered with the chat service (hereinafter referred to as “unregistered members”), the unregistered members were encouraged to become registered members or communication was carried out using methods other than chat. While there are services allowing for chat between unregistered members and registered members using modality conversion technologies, they are not very convenient to use because, when used, they require time and effort to meticulously enter all the information about the unregistered members, impose restrictions on the use of the services, and so forth.

The present invention eliminates the above-mentioned inconveniences and allows for a chat service to be implemented in a very smooth manner without making users aware of the service registration status of their chat partners. In addition, the present invention can be employed in cases where 3 or more users (who may include unregistered members) engage in chat. Below, explanations will be provided with reference to examples.

### Working Example 1

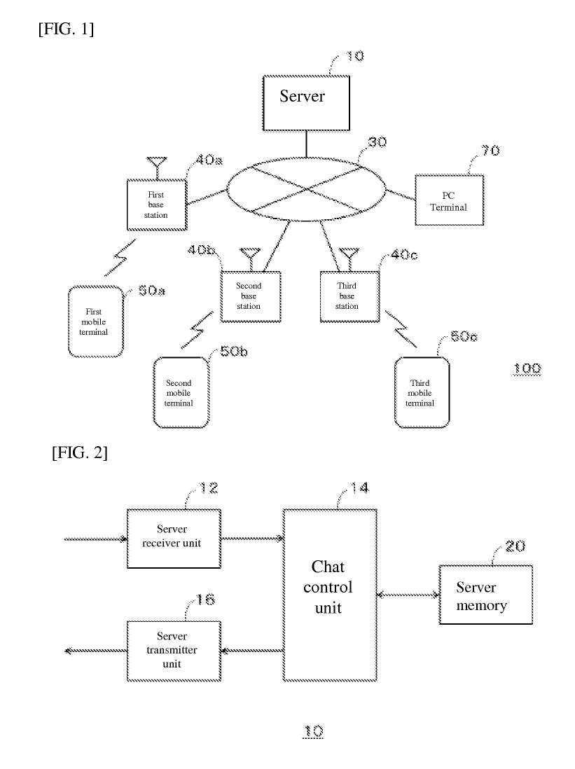

First of all, Working Example 1 will be described. FIG. 1 is a diagram illustrating a chat system 100 according to Working Example 1 of the present invention. The chat system 100 includes: a server 10; a network 30, which connects the server 10 and base stations 40 through wired connections; first base station 40a-third base station 40c, which are represented as the base stations 40; first mobile terminal 50a-third mobile terminal 50c, which are represented as the mobile terminals 50; and a PC terminal 70.

It should be noted that while only three base stations 40 and three mobile terminals 50 are shown for convenience of illustration, the number is not limited and there may be more base stations 40 and mobile terminals 50. The same applies to the PC terminal 70. In addition, while the first mobile terminal 50a-third mobile terminal 50c are depicted as respectively connected to different base stations 50, this need not be the case and, quite naturally, the present invention can be employed even if multiple mobile terminals 50 are connected to a single base station 50.

The server 10 is an apparatus used to implement and provide the chat service. The server 10 carries out communication processing used for chat processing between the mobile terminals 50 and PC terminal 70 via the network 30 and base stations 40. It should be noted that, for simplicity of description, the discussion below uses expressions such as “carries out communication processing between the server 10 and the mobile terminals 40 along with the PC terminal 70” and omits the fact that this is done via the network 30 and base stations 40. In addition, in the discussion below, the mobile terminals 50 and PC terminal 70 are sometimes collectively referred to as “user terminals”.

The server 10 allows for an application to be downloaded in response to a request from a user terminal. Subsequently, it allows for contact information stored in the memory of the user terminal to be uploaded and imported into the memory of the server 10. If a chat service initiation request arrives from the user terminal, the server 10 determines the modality used by the chat service for communication with the remote party. Specifically, it determines the most suitable communication modality based on registration information stored in the memory of the server 10 in accordance with information on communication modality priority, converts the message transmitted from the user terminal to this communication modality, and transmits it to the remote party.

In principle, if the destination party is a registered member, the chat modality is selected as the communication modality employed when communicating with the remote destination party. On the other hand, if the destination party is an unregistered member, a modality is selected that corresponds to the information registered in memory in association with the unregistered member. Further details are discussed below. In accordance with this aspect, the user can engage in chat with an unregistered member without being aware that remote party is an unregistered member.

When using the chat service, first of all, a user terminal accesses the server 10 and then downloads and installs an application. Next, in response to a request from the server 10, it uploads the contact information registered in the terminal. After that, in order to use the chat service, it is sufficient to launch the application, designate a destination, and create and transmit a message directed to the destination. It should be noted that, as has been described above, when the chat system 100 is used, whether or not the destination user is an unregistered user is inconsequential to the person using the user terminal.

FIG. 2 is a diagram illustrating an exemplary configuration of the server 10 in the chat system 100 of FIG. 1. The server 10 includes a server receiver unit 12, a chat control unit 14, a server transmitter unit 16, and a server memory 20.

The server receiver unit 12 receives a signal from a user terminal, carries out predetermined demodulation processing, and sends the demodulated signal to the chat control unit 14. The server transmitter unit 16 transmits a predetermined message to the destination party using the communication modality selected by the chat control unit 14. Conventional modulation/demodulation technology may be used for the modulation/demodulation processing in the server receiver unit 12 and server transmitter unit 16, and it will be understood by those skilled in the art that the present invention can be employed even in such an aspect.

The chat control unit 14 receives the signal from the server receiver unit 12, carries out processing according to its content, accesses the server memory 20, and instructs the server transmitter unit 16 to transmit it. The signal received from the server receiver unit 12 is a signal from the user terminal, such as, for example, a request to download an application used for running the chat service (hereinafter referred to as “chat application”), information uploaded from the user terminal, a destination, or a message directed to the destination or the like.

The chat control unit 14 reads the chat application intended for downloading by the user from the server memory 20, imports the contact information transmitted from the user terminal, and accesses information used for determining the communication modality. The chat control unit 14 allows for the application to be downloaded to the user terminal in response to a request from the user terminal. Once it has been downloaded to the user terminal, the chat control unit 14 queries the user terminal as to whether to import the contact information stored in the user terminal into said server 10. If a permission to import is obtained, the contact information is sent from the user terminal and, accordingly, the chat control unit 14 writes said information to the server memory 20.

In addition, when determining the modality for communication with the destination, the chat control unit 14 selects one communication modality from one or more communication modalities registered in the server memory 20 in association with the destination based on information indicating the order of priority of the communication modalities to be employed. Details regarding selection and the “information indicating the order of priority of the communication modalities to be employed” will be described below.

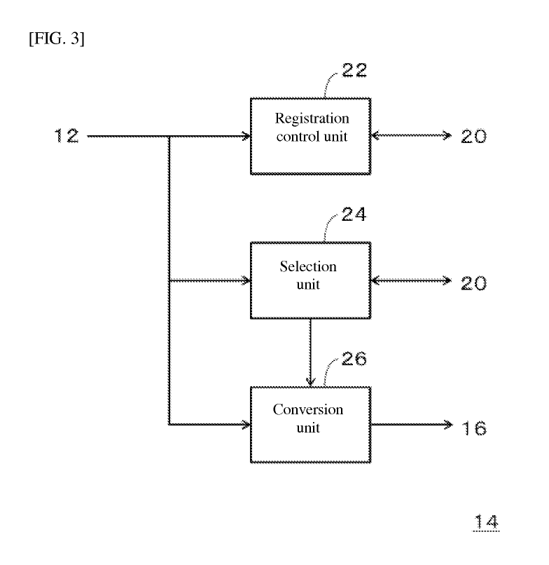

FIG. 3 is a diagram illustrating an exemplary configuration of the chat control unit 14 in the server 10 of FIG. 2. The chat control unit 14 includes a registration control unit 22, a selection unit 24, and a conversion unit 26. The registration control unit 22 carries out processing to register contact information acquired from the user terminals in the server memory 20. In response to a chat request from a user terminal, the selection unit 24 acquires destination information by accessing the server memory 20, determines the modality for communication with the destination, and transmits it to the conversion unit 26. The conversion unit 26 converts the message directed to the destination received from the user terminal to the format of the communication modality transmitted from the conversion unit 26. The conversion performed by the conversion unit 26 may be done using publicly known methods. This will be described in sequence below.

In response to the installation of the chat application on the user terminal and the uploading of the contact information from the user terminal, the registration control unit 22 registers this contact information in the server memory 20. At such time, the registration control unit 22 assigns an ID to the user terminal acting as the uploader.

Furthermore, the registration control unit 22 matches the uploaded contact information with registered member contact information. The “registered member contact information” is the contact information of the members already registered with the chat service. In addition, the registration control unit 22 may match the uploaded contact information with registered contact information. The “registered contact information” is contact information that is stored in the server memory 20 and includes unregistered member contact information already imported by other registered users.

The “contact information” includes names, furigana spellings, phone numbers, cellular phone numbers, e-mail addresses, SNS (Social Networking Service) information, membership information, and the like. Items such as phone numbers, cellular phone numbers, e-mail addresses, or SNS information may have multiple entries. The SNS information includes one or more information items required for identifying users in SNS such as Facebook, Twitter, Mixi, LinkedIn (all of the four names above are registered trademarks) and for contacting the users. The membership information, which indicates whether or not an application used for running the chat service has been installed, serves as a flag used to distinguish between registered members and unregistered members.

If a common portion is found in the two pieces of contact information as a result of matching, the registration control unit 22 stores the two pieces of contact information in consolidated form. For example, assuming that the two pieces of contact information shown below are used, then the names and cellular phone numbers in both pieces of contact information are identical. For this reason, both pieces of contact information can be presumed to be associated with the same person.

Uploaded contact information

| | |
|---|---|
| Name | A |
| Cellular phone number | 090-XXX-YYYY |
| E-mail address | b@ppp.co.jp |

Registered contact information

| | |
|---|---|
| Name | A |
| Cellular phone number | 090-XXX-YYYY |
| Phone number | 03-mmmm-nnnn |
| E-mail address | a@qqq.ne.jp |

Accordingly, the registration control unit 22 consolidates the above-mentioned two pieces of contact information and stores them in the server memory 20 as the following single piece of contact information.

Consolidated contact information

| | |
|---|---|
| Name | A |
| Cellular phone number | 090-XXX-YYYY |
| Phone number | 03-mmmm-nnnn |
| E-mail address | a@qqq.ne.jp |
| E-mail address | b@ppp.co.jp |

It should be noted that if the two pieces of contact information are completely identical, the registration control unit 22 may not have to perform consolidation processing. This is due to the absence of mutually complementary information. In addition, during consolidation, the number of common portions may be used as a condition for determining whether to perform consolidation, a match between one or more predetermined information items may also be used as a condition, and a combination thereof may be used as well. This is due to the fact that the larger the number, the higher the probability of being associated with the same person. In addition, for example, when names and cellular phone numbers are used as the one or more predetermined information items, this makes it possible to use contact information that remains unchanged or is unlikely to be modified as a criterion and, for this reason, the probability of being associated with the same person is made even higher. It should be noted that although there is a tradeoff relationship between raising the probability and aspects such as processing speed and processing load, in view of these factors, the above-mentioned number is preferably 2 or 3, and the predetermined information is preferably a combination of a name and a cellular phone number and/or a phone number.

The selection unit 24 will be described next. The selection unit 24 selects one communication modality from one or more communication modalities registered in the server memory 20 in association with the received destination user based on information indicating the order of priority of the communication modalities to be employed. However, the operation of the selection unit 24 varies depending on whether or not the message received from the server receiver unit 12 is in chat format. This is due to the fact that in the case of the chat format, the message is from a registered user, and in the case of a format other than chat, the message is from an unregistered user.

Here, a case, in which a message received from the server receiver unit 12 is in chat format, will be discussed with reference to examples. In this example, it is assumed that contact information associated with User A, User B, and User C shown below is stored in the server memory 20.

### User A

Name

E-mail address

Registered member

### User B

Name

E-mail address

SNS information

Unregistered member

### User C

Name

E-mail address 1

E-mail address 2

Unregistered member

In addition, suppose that the information indicating the order of priority of the communication modalities to be employed (hereinafter referred to as “priority information”) has been configured in the following manner. It should be noted that this priority information is, for example, the following information. Priority 1 indicates the highest priority and the larger the number, the lower the priority.

Priority 1 Chat format

Priority 2 E-mail format

Priority 3 SNS format

It should be noted that this priority information may be configured individually for each registered user. In addition, registered users may perform configuration in a discretionary manner. In addition, the chat format may be always configured as Priority 1, and in such a case, the users can configure formats of Priority 2 or lower in a discretionary manner.

As in the case above, a case will be discussed in which User A is the destination. First of all, the selection unit 24 acquires membership information from the contact information stored in association with the destination. Here, the membership information is used to determine that the destination user is a registered member and, in such a case, the chat format is selected.

Here, the selection unit 24 instructs the conversion unit 26 to convert the received message to the chat format. It should be noted that in the case of a registered member, the selection unit 24 may select the chat format without accessing the priority information.

A case in which User B is the destination will be discussed next. Unlike the above-described case of User A, User B is an unregistered member. In such a case, the selection unit 24 references Priority 2 in the priority information. Here, Priority 2 is e-mail format and, for this reason, the selection unit 24 performs a match to determine whether an e-mail address is present in User B's contact information.

In the above-described example, User B has an e-mail address and, for this reason, the selection unit 24 selects the e-mail format as the communication modality. It should be noted that if no e-mail address had been registered for User B, a determination is made as to whether information has been registered for the SNS format, which is the next Priority 3, and, since in such a case SNS information has been registered as User B's contact information, the selection unit 24 would select the SNS format.

A case in which User C is the destination will be discussed next. In accordance with User C's registration information, since User C is an unregistered member, the selection unit 24 checks whether or not an e-mail address is present in User C's registration information in order to determine whether it is possible to select the e-mail format, which is Priority 2. Here, User C's registration information has two e-mail addresses. In such a case, the selection unit 24 selects the e-mail address for the cellular phone as a priority.

It should be noted that an e-mail address registered at a later time may be selected if two or more cellular phone e-mail addresses have been registered. This is due to the fact that the e-mail address registered at a later time may represent the most recently registered new information and thus can be used to deliver messages to User C in a more reliable manner.

In addition, although the e-mail format is configured as Priority 2 in the priority information, its priority may be configured according to the destination, as illustrated in the following Example 2 of priority information.

### Example 2 of Priority Information

Priority 1 Chat format

Priority 2 E-mail address for destinations other than cellular phone

Priority 3 E-mail address for cellular phone

In addition, it is possible to configure a general-purpose e-mail address that may be intended either for a cellular phone or for another destination, such as gmail.com or another free e-mail address, as illustrated in the following Example 3 of priority information. Configuring the priority information in this manner allows for the destination to be selected in a more flexible way and deliver messages to the destination in a more reliable manner.

### Example 3 of Priority Information

Priority 1 Chat format

Priority 2 General-purpose e-mail address

Priority 3 E-mail address for cellular phone

Priority 4 E-mail address for destinations other than cellular phone

If the destination is an unregistered user, the conversion unit 26 attaches URL information to the message received from the server receiver unit 12. The “URL information” represents information related to links to web pages providing an introduction to the chat system for the unregistered user. By clicking on this information, the unregistered user can access the server 10 and download the chat application used for chat from there. Subsequently, the conversion unit 26 converts the message to be transmitted to the communication modality indicated by the selection unit 24 and sends it to the server transmitter unit 16.

Next, an explanation will be provided regarding a case in which a message received from the server receiver unit 12 is in a format other than chat. In this case, the message is a message from an unregistered user to a registered user. For this reason, in the server memory 20, the registration information of the destination user refers to a registered user. Here, the chat format corresponds to Priority 1 of the priority information associated with the registered member. Accordingly, as described above, the selection unit 24 selects the chat format as the communication modality for messages intended for the registered user.

Next, the conversion unit 26 converts the message received from the unregistered member to the chat format. The converted message is transmitted to the destination user terminal 50 via the server transmitter unit 16. On the user terminal 50, the transmitted message is displayed on the chat interface screen on the terminal display. In accordance with the aspect above, in the chat system 100, appropriate conversion of communication modalities based on the priority information and contact information stored on the server 10 allows for smooth chat between registered members and unregistered members to be implemented without causing users to perform redundant operations.

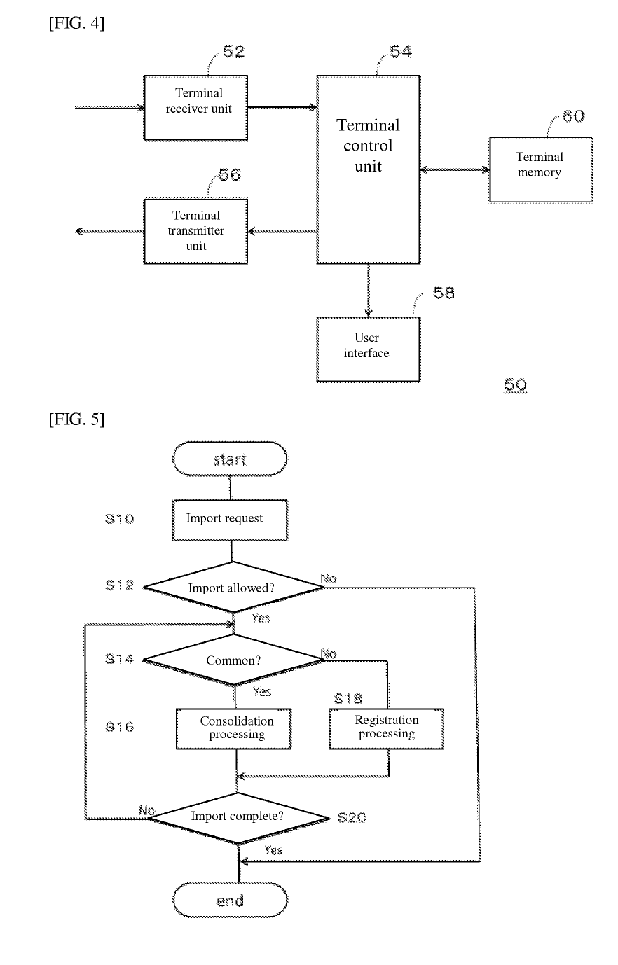

The configuration used on the user terminal side will be described next. FIG. 4 is a diagram illustrating an exemplary configuration used for the mobile terminals 50 or PC terminal 70 of FIG. 1. Although the configuration of a mobile terminal 50 will be discussed here for purposes of convenience in description, the same configuration is used for the PC terminal 70.

The mobile terminal 50 is provided with a terminal receiver unit 52, a terminal control unit 54, a terminal transmitter unit 56, a user interface 58, and a terminal memory 60. The terminal receiver unit 52 receives the chat application downloaded from the server 10, messages from other users transmitted by the server 10, and the like.

Upon receiving instructions from the user, the terminal control unit 54 controls the installation of the chat application while accessing the terminal memory 60, controls the uploading of the contact information registered in the terminal memory 60, or selects the destinations for chat, manages messages sent to the destinations, and so forth.

In addition, the user interface 58 displays messages directed to the user on screen and, upon receiving instructions from the user entered by operating a keyboard, a touch panel, or the like, transmits them to the terminal control unit 54. The messages directed to the user include, for instance, queries as to whether or not the contact information stored in the memory 60 may be imported into the server 10, designation of the destinations to be used during chat, editing screens used for messages directed to the destinations, and the like. These messages may be displayed on a predetermined chat interface screen.

Below, an explanation will be provided regarding the general operation of the mobile terminal 50, as an example of a situation in which User A initiates the use of the chat service.

It is assumed that User A has a chat application installed on User A's mobile terminal 50. At such time, a popup message, such as “Import Address Book?” or the like, is displayed on the user interface 58 by the terminal control unit 54 and, if the user presses the “Yes” button in response, the contact information stored in the terminal memory 60 is imported into the server memory 20 of the server 10.

It should be noted that when the chat application is installed, the contact information stored in User A's terminal memory 60 may be automatically imported into the server 10 without showing popup displays or the like. In addition, import processing may be carried out in a periodic manner and, in addition to that, import processing may be carried out when new contact information is added to the terminal memory 60.

Next, on the server 10, the phone numbers, e-mail addresses, and the like contained in the contact information are matched with the registered member contact information stored on the server 10, and, if there is a matching registered member, the registered member contact information and the imported address information are combined.

If the chat application is installed in this manner, then the contact information entries related to the user's acquaintances registered in the terminal memory 60 of the mobile terminal 50 are automatically registered as chat partners. For this reason, the user can start using the chat service without stress.

Next, an explanation will be provided regarding an exemplary situation in which User A exchanges messages with User B via chat.

When User A starts the chat application, the user interface 58 displays candidate destinations. For example, User A selects User B from the displayed candidates as the destination party of the message. The selected destination is informed by the server 10 via the terminal control unit 54 and terminal transmitter unit 56.

Next, the server 10 determines the message communication modality (chat, e-mail, SNS) based on User B's contact information and priority information. As described above, the “priority information” is information indicating the order of priority used to select which communication modality to use when sending messages. For example, if the order of priority is Chat>SNS message>E-mail address>SMS and User B is a registered member of the chat service, the communication modality is chat. In addition, if User B is an unregistered member and only an e-mail address and a phone number are known, the selected communication format is based on the e-mail format, which has a higher order of priority.

When User A enters a message for User B in the message field of the chat interface screen displayed on screen by the user interface 58 and presses the Send button, the message is transmitted to User B via the terminal control unit 54, terminal transmitter unit 56, and server 10. If the e-mail modality is selected as the modality for communication with User B, the server 10 converts User A's chat message to the e-mail format and an e-mail is transmitted from the server 10 to User B's e-mail address imported from the terminal memory 60.

When User B, who is an unregistered user, receives the message in e-mail format from User A and replies to this message in e-mail format, the server 10 starts by converting the e-mail from User B to a message in chat format and transmits it to User A's mobile terminal 50, where it is displayed on the chat interface on the display of the terminal.

FIG. 5 is a flow chart illustrating a first processing procedure of the chat control unit 14 of FIG. 3. This first processing procedure is initiated in response to the downloading of the application to the user terminal.

First of all, the chat control unit 14 issues an import request directed to the user terminal via the server transmitter unit 16. The “import request” is used to pose a query as to whether or not the contact information stored in memory on the user terminal may be uploaded to the server 10 and stored in the server memory 20 on the server 10.

Here, if a signal which indicates that importing is not permitted is received from the user terminal by the server receiver unit 12 (“No” in S12), the chat control unit 14 terminates the process. On the other hand, if a signal which indicates that importing is permitted is received from the user terminal (“Yes” in S12), the subsequently transmitted contact information is acquired via the server receiver unit 12.

If, as a result of matching the acquired contact information with the contact information already registered in the server memory 20, it is found that there is common information (“Yes” in S14), the registration control unit 22 consolidates the contact information stored in the server memory 20 with the acquired contact information (S16). On the other hand, if there is not common information (“No” in S14), the registration control unit 22 registers the acquired contact information in the server memory 20 “as is” (S18). An ID, or the like, used to identify the contact information may be attached at such time.

Here, if all the contact information to be imported has been imported (“Yes” in S20), the chat control unit 14 terminates the process. On the other hand, if there is other contact information (“No” in S20), the chat control unit 14 goes back to the processing of S14 and repeats the processing of S14-S20 until there is no contact information to be imported.

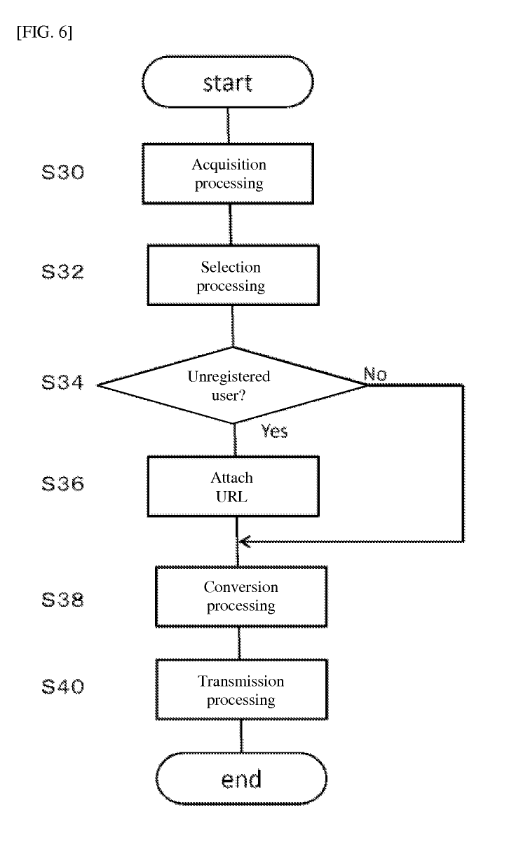

FIG. 6 is a flow chart illustrating a second processing procedure of the chat control unit 14 of FIG. 3. This second processing procedure is initiated in response to the start of chat by the user terminal.

The chat control unit 14 uses the server receiver unit 12 to acquire a destination specified by the user and a message to be transmitted to said destination (S30). Next, the selection unit 14 selects one communication modality from one or more communication modalities in the contact information registered in the server memory 20 in association with the destination based on priority information indicating the order of priority of the communication modalities to be employed (S32).

Here, if the destination is an unregistered user (“Yes” in S34), the chat control unit 14 attaches URL information to the message to be transmitted in order to encourage the unregistered user to join the chat system (S36). In the case of a registered user (“No” in S34), the procedure advances to the processing of S38.

The chat control unit 14 subjects the message to be transmitted to processing whereby it is converted to the communication modality selected in S32 (S38). Next, the chat control unit 14 directs the server transmitter unit 16 to transmit the converted message to the destination specified by the user (S40).

In accordance with the aspect above, the communication modality is automatically configured by selecting one communication modality from among one or more communication modalities registered in memory in association with a received destination based on information indicating the order of priority of the communication modalities to be employed, thereby alleviating the burden placed on the user when sending messages.

In addition, the burden on the user at the time when the use of the service is initiated can be alleviated by combining the acquired contact information with the registered contact information if, as a result of matching the acquired contact information with the registered contact information, it is found that common information is contained in the two pieces of contact information.

### Working Example 2

Working Example 2 will be described next. First of all, a summary will be provided. In Working Example 2, in addition to the aspects of Working Example 1, messages arbitrarily selected by the user from among messages displayed on the chat interface can be saved on the server 10. At such time, the server 10 can receive selections made by multiple users. Flags, for example, pin symbols and the like, may be attached to the selected messages and displayed on screen in the form of a pin board, such as the one illustrated later. The chat participants can verify the selected messages using this pin board.

Furthermore, in Working Example 2, the pin board can be converted to a web page and uploaded to the web. As a result, the selected messages can be extensively shared. In addition, if it is desirable to limit the number of people with access to the web page, a password may be assigned to the web page. As a result of using the aspect above, Working Example 2 is particularly suitable for chat conferences in business, event scheduling, and the like. Below, detailed explanations will be provided with reference to the drawings. It should be noted that when the same configuration as in Working Example 1 is used, the same numerals are assigned and the explanations are omitted.

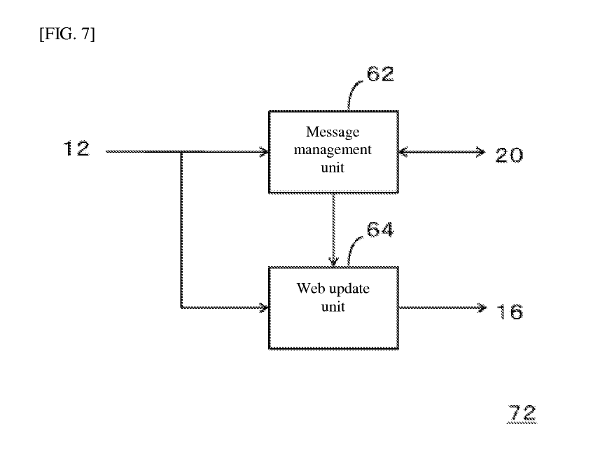

FIG. 7 is a diagram illustrating an exemplary configuration of a chat control unit 72 according to Working Example 2 of the present invention. The chat control unit 72 is provided with a message management unit 62 and a web update unit 64. It should be noted that the registration control unit 22, selection unit 24, and conversion unit 26 included in the chat control unit 14 have been omitted.

First of all, the user selects one or more messages displayed on the chat interface on the display of the user terminal 50 and, with a flag designating its selected status being displayed in the selected message, sends information used to identify the selected message to the server 10. The “information used to identify the selected message” (hereinafter referred to as “selected message identification information”) may be represented by an identification number used to identify the message and by a flag associated with this identification number.

The message management unit 62 of the server 10 acquires the selected message identification information via the server receiver unit 12 and, in order to manage the message as a message selected by the user, stores the selected message identification information in association with a user ID in the server memory 20. In addition, the message management unit 62 may store the message itself in the server memory 20.

Here, if the user uses the chat interface to issue a request to display all of the messages selected by the user in the past at once, the user terminal 50 issues a request to instruct the server 10 to display them. In response to receiving the display request-related instructions from the user, the message management unit 62 of the server 10 acquires the selected message identification information by accessing the server memory 20 and conveys the corresponding messages to the web update unit 64. The web update unit 64 carries out processing in order to display the messages identified based on the selected message identification information on the web page.

It should be noted that the web update unit 64 may require a password from the user when allowing the user to view the selected messages. As a result, security can be increased. This can enable sharing of the messages by multiple users because the selected messages can be viewed if the password is known to users other than the user who performed the selection.

In addition to managing the messages identified based on the message identification information, the message management unit 62 may also concomitantly manage the message identification information associated with these messages. In such a case, the selected message identification information acquired from the user terminal 50 and information indicating how many messages should be managed among the messages that follow the message corresponding to this selected message identification information is stored in the server memory 20 by the message management unit 62. This information is provided by the user terminal 50. In accordance with this aspect, a specific topic in its entirety can be managed and displayed as a single thread.

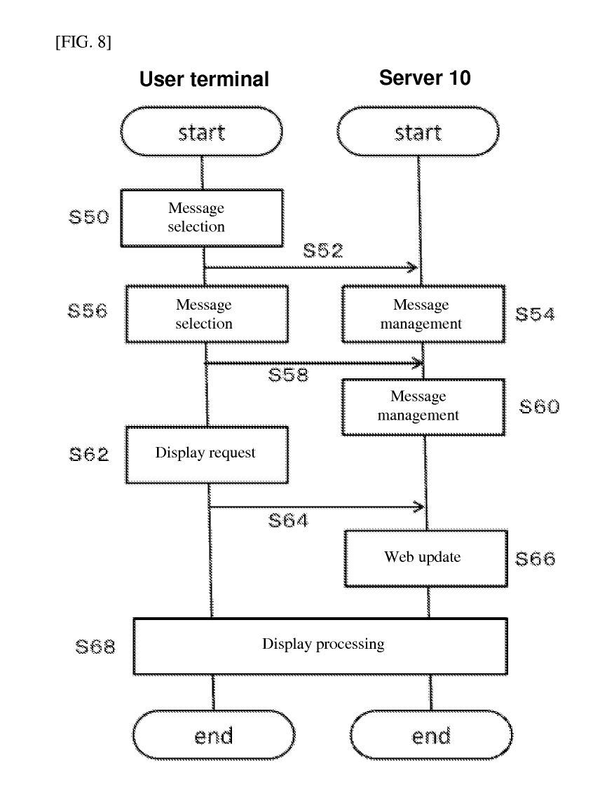

FIG. 8 is a sequence diagram illustrating an exemplary processing procedure based on message management by the server 10 and user terminals according to Working Example 2 of the present invention.

First of all, in accordance with instructions from the user, the user terminal selects messages (S50, S56). Next, the user terminal conveys the selected message identification information corresponding to the selected messages to the server 10 (S52, S58). The server 10 manages the selected messages in the server memory 20 based on the selected message identification information provided by the user terminal (S54, S60). It should be noted that while an example that involves selection of 2 messages is depicted in FIG. 8, this need not be the case, and a message may be selected only once, or three or more times.

Here, if the user terminal receives a display request (S62), the user terminal conveys instructions to the server 10 to display the messages selected by the user in the past (S64). In response to the instructions from the user terminal, the server 10 performs web update processing used to display the messages managed by the server memory 20 on the web page (S66). Finally, the user terminal accesses the server 10 and displays the web page used to view the messages on the display (S68).

### Working Example 3

Working Example 3 will be described next. First of all, a summary will be provided. In Working Example 3, scheduling management of events and the like can be performed on the chat interface. A user creates an event in the chat system and asks his or her chat partners to respond regarding possible attendance of the event. In addition, the replies received from the chat partners are automatically aggregated and the user can view the aggregated results.

In addition, instead of simply asking about attending an event, it is possible to produce several time and location candidates for holding the event and ask the chat partners to respond regarding each candidate. For the unregistered members of the chat service, the URL of a web page used for determining possible attendance of the event and the desired date is provided in the body of the e-mail. Alternatively, this may be done by providing separate URLs for attendees and non-attendees, such that clicking on the attendee URL produces a response that means “Yes, I will attend” and clicking on the non-attendee URL produces a response that means “No, I will not attend”.

Such scheduling management of events and the like may have the following functionality.

(1) The user who organizes the event can fine-tune the planned event with friends and family. It is possible to receive responses regarding possible attendance, desired time, and desired location, and the organizer can have a list of aggregated results.
(2) It is possible to vote on the time of the event and tally the results. There may be multiple time candidates. The same applies to the location. There may be different options depending on the venue of the event.
(3) The respondents can choose answers from multiple options such as “◯”, “Δ”, and “x” for each schedule.
(4) Events can be held without specifying time, e.g. “Hiring Now”.
(5) Reminders can be sent to users who do not respond by a predetermined date. In addition, in the case of would-be attendees, for example, a message can be sent to the attendees 24 hours prior to the event.
(6) In addition to using the chat interface, this can be implemented in the same manner in a web browser, and both will be synchronized. For this reason, even an unregistered user of the application can readily use this functionality.

In order to implement the above functionality, the server managing the chat system, in accordance with user instructions, creates event information obtained by combining, respectively, one or more time candidates with one or more location candidates, and poses a query as to possible attendance of the event associated with the created event information. If a communication modality other than chat was selected when the unregistered user was queried about possible attendance of the event, a message may be included in order to transmit URL information for receiving responses from the user about possible attendance.

Below, detailed explanations will be provided with reference to the drawings. It should be noted that when the same configuration as in Working Examples 1 and 2 is used, the same numerals are assigned and the explanations are omitted.

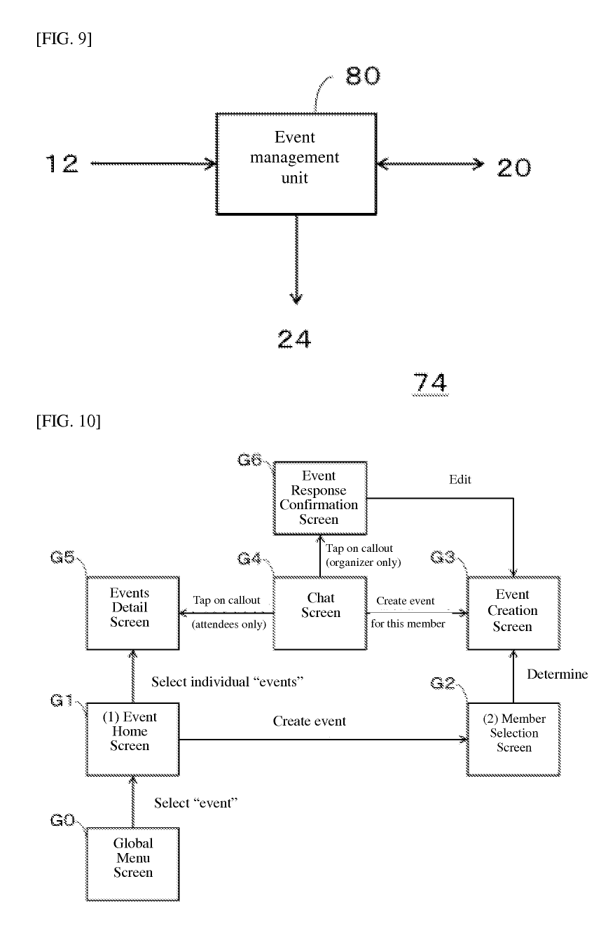

FIG. 9 is a diagram illustrating an exemplary configuration of a chat control unit 74 according to Working Example 3 of the present invention. The chat control unit 74 includes an event management unit 80. It should be noted that the registration control unit 22, selection unit 24, and conversion unit 26 included in the chat control unit 14 have been omitted.

In response to event-related instructions received from the user via the server receiver unit 12, the event management unit 80 accesses the server memory 20 and manages event-related information. Event-related information input from the user, user-related information encouraging event attendance, and the like, are included in the event-related instructions.

In addition, in response to event-related instructions from the user, the event management unit 80 displays a predetermined screen on the chat interface screen of the display of the user terminal. Below, explanations will be provided with reference to examples.

FIG. 10 is a diagram illustrating an exemplary transition on the chat interface screen according to Working Example 3 of the present invention. The chat interface screen includes a Global Menu Screen G0, an Event Home Screen G1, a Member Selection Screen G2, an Event Creation Screen G3, a Chat Screen G4, an Event Details Screen G5, and an Event Response Confirmation Screen G6.

Event information managed in the server memory 20 of the server 10 is updated on the chat interface screens from G0 to G6 in response to instructions received from the user and transitions to the respective screens performed as shown in FIG. 10 depending on the updates.

When the user initiates chat, first of all, the Global Menu Screen G0, which is the initial screen of the chat system 100, is displayed on the user terminal. Here, if the user issues a request about event-related processing, a transition to the Event Home Screen G1 is effected. Using this Event Home Screen G1 as a starting point, the user creates and manages events.

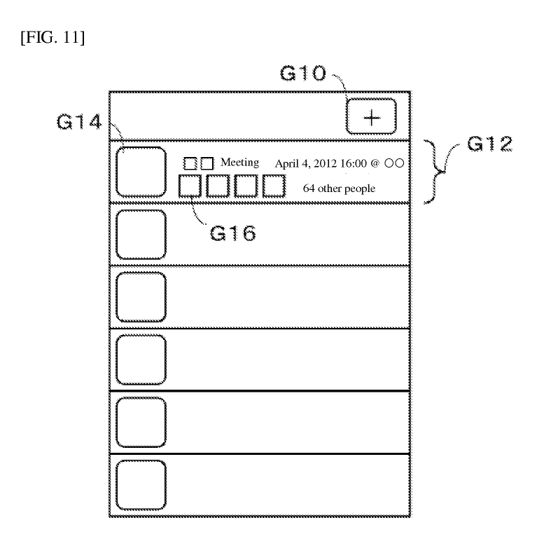

FIG. 11 is a diagram illustrating an exemplary display on the Event Screen G1 of FIG. 10. The Event Screen G1 is a screen obtained as a result of transition from the Global Menu Screen G0 and provides consolidated management of events. Using this screen, the user can check events that are in progress or events that the user attended in the past. As shown in the figure, a new event creation button G10 and event fields G12 are displayed on the Event Screen G1. Event images G14 and event attendee images G16 are displayed in the event fields G12.

When creating a new event, the user can create an event by tapping on the new event creation button G10. When an event is created, the screen transitions to the Member Selection Screen G2 and a screen is displayed that allows the user to select members to be queried about attending the event.

The title, time, location, and an attendee list for the event are displayed in the event field G12. When the user taps on the individual event fields, a transition to the Event Details Screen G5 takes place. The newly created event is displayed in the upper portion of the event field G12 and events preceding it are displayed in the lower portion. If an event is over or if the event itself has been deleted, it is deleted from the event field G12. It should be noted that a display process different from the one used for the new event may be applied to the events displayed in the lower portion, for example, they may be displayed using a lighter shade of color.

Images that show events specified during event creation are displayed in the event images G14. When no event is specified, an arbitrary image may be displayed. Images specified by the users who have already said that they will attend the event are displayed in the event attendee images G16.

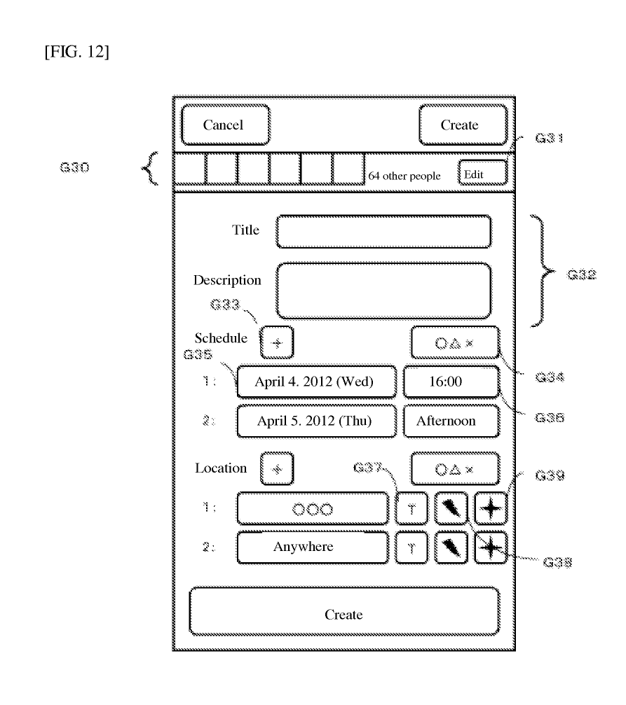

FIG. 12 is a diagram illustrating an exemplary display on the Event Creation Screen G3 of FIG. 10. Queried member images G30, a member editing button G31, event description fields G32, a candidate addition button 33, a response candidate button G34, schedule candidate fields G35, time candidate fields G36, free entry buttons G37, map view buttons G38, and search buttons G39 are displayed on the Event Creation Screen G3.

Images corresponding to the members who have been queried about attendance are displayed in the queried member images G30. When the user taps on the member editing button G31, a transition to the Member Selection Screen G2 takes place. The event description fields G32 are fields used for entering an event title and an event description. It should be noted that entering a title is mandatory. The candidate addition button 33 is a button that the user taps on when adding another schedule, time, or location candidate. As shown in the figure, when the user taps on it, an additional candidate is displayed.

The response candidate button G34 is a button the members who have been queried about attendance tap on. It is a button used to select the degree of probability of attendance of the event held in accordance with the displayed schedule, time, and location from several options. Although there are three options here, i.e. ◯, Δ, and x, this does not have to be the case.

The schedule candidate fields G35 and time candidate fields G36 are fields used to enter the date and time at which an event is held. As described above, if there are multiple candidates added using the candidate addition button 33, the information is entered for each candidate.

The free entry buttons G37 are buttons the user taps on when entering comments regarding the location. The map view buttons G38 are buttons used by the event creator to configure information indicating said location. These buttons are used by the users queried about event attendance to display information on the location. The location information may include an address and a phone number, it may be map information, and it may be a combination of the above. The search buttons G39 are buttons used by the users queried about event attendance to effect a transition to a screen used to search for information related to the location using a predetermined search tool.

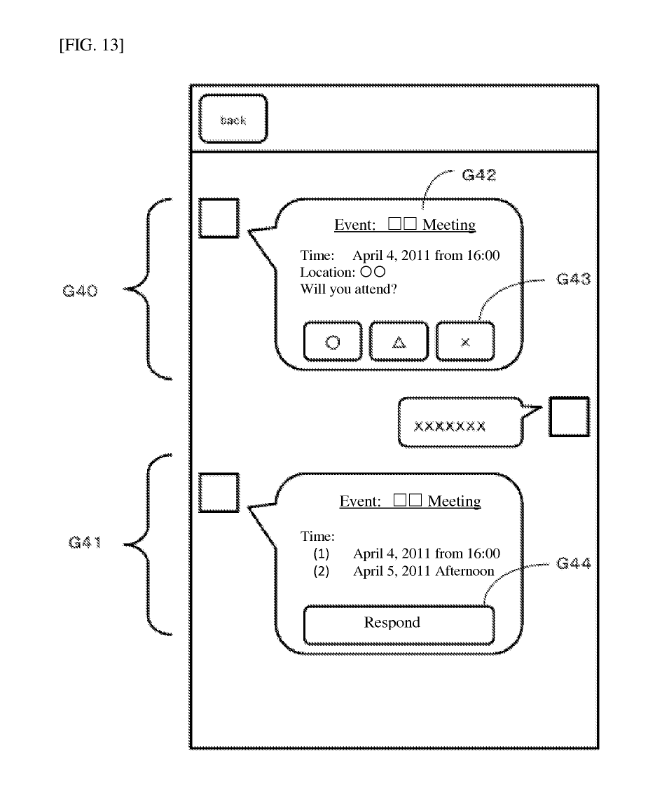

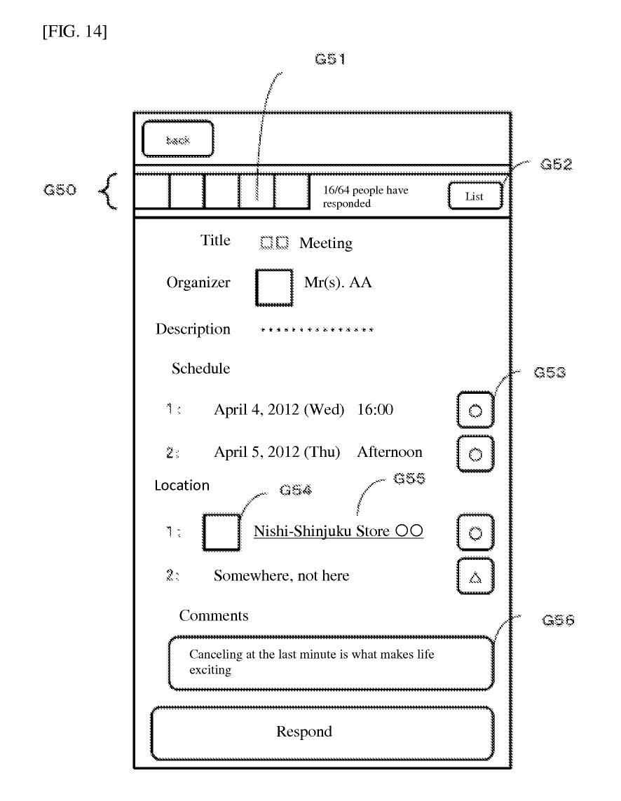

FIG. 13 is a diagram illustrating a first exemplary display on the Chat Screen G4 of FIG. 10. This Chat Screen G4 is a screen displayed on the chat interface of the users queried about attendance of a created event. The Chat Screen G4 displays a single response mode field G40, an option mode field G41, an event description field G42, option buttons G43, and a response button G43.

The single response mode field G40 is a screen displayed in cases in which only one event time and location is configured for the created event. The name, time, and date of the event, as well as the option buttons G43, are displayed in the event description field G42. By tapping on the name of the event, users queried about attendance transition to the Event Details Screen G5. As shown in the figure, the response buttons G44 respectively have symbols “◯”, “Δ”, and “x” displayed thereon. By tapping on any one of them, users queried about attendance of the event can express their willingness to attend the event.

Unlike the single response mode field G40, the option mode field 41 is a screen displayed in cases in which multiple times and locations are configured for one created event. In the option mode, the user transitions to the Event Details Screen G5 by tapping on the response button G44. Using the Event Details Screen G5, the user expresses his or her willingness to attend regarding the respective options.

FIG. 14 is a diagram illustrating an exemplary display on the Event Details Screen G5 of FIG. 10. Would-be attendee user images G50, non-responding user images GM, a list view button G52, response buttons G53, a store image G54, a store link G55, and a comment field G56 are displayed on the Event Details Screen G5.

Images specified by the users who have already said that they will attend are displayed in the would-be attendee user images G50. It should be noted that in the case of a 3-option response format, it is possible to display only users who responded with a “◯”, or display users who responded with a “◯” or a “Δ”, or display by changing the manner in which they are displayed, e.g. by changing the color of the “◯” and “Δ”

Images specified by the users who have not responded are displayed in the non-responding user images G51. They may be displayed in a manner different from the would-be attendee user images G50. For example, in FIG. 14, they are displayed using a whitish color tone.

The list view button G52 is a button used for transitioning to a Friends List Screen. If the user taps on the response buttons G53, response options are displayed. Responses are displayed by selecting any one of them. As shown in the figure, if there are multiple times and locations, multiple response buttons G53 are displayed.

The store image GM displays an image depicting a store, for instance, where the event is held, which is specified in advance. A web page that shows information on the store is displayed when the user taps on the store link G55. The comment field G56 is a field for users who have provided responses about event attendance to enter comments.

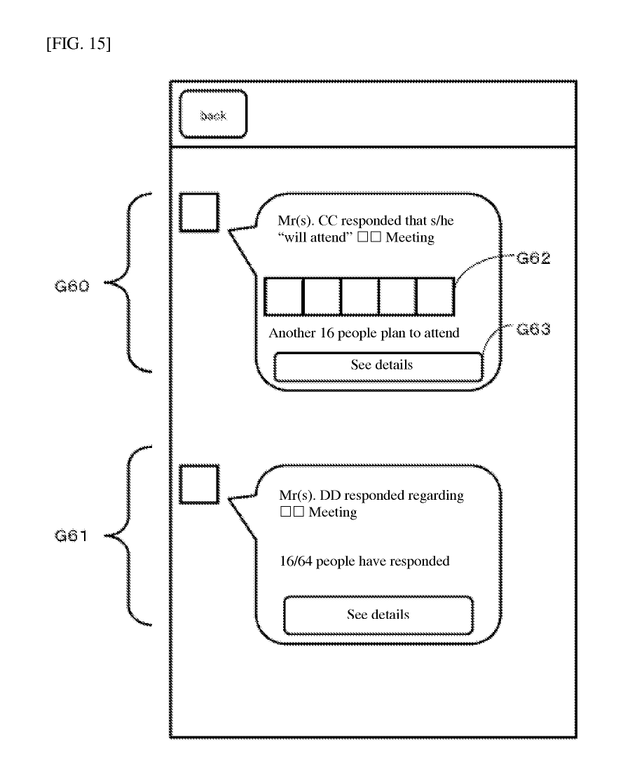

FIG. 15 is a diagram illustrating a second exemplary display on the Chat Screen G4 of FIG. 10. The second exemplary display is an example of a screen displayed if a user responds to a query about event attendance in the case of the exemplary display of FIG. 13 or the Event Details Screen G5 of FIG. 14. In the second exemplary display, a single response mode display field G60 and an option mode field G61 are displayed in response to an event for which a response has been obtained. Would-be attendee user images G62, which are specified by the users who have said that they will attend, and a transition button G63, which is used for transitioning to the Event Details Screen G5, are displayed in the respective fields.

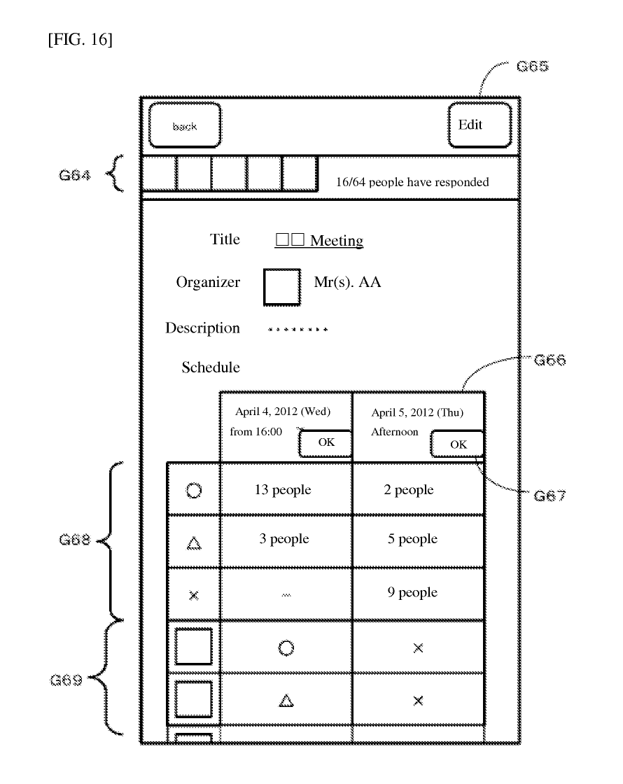

FIG. 16 is a diagram illustrating an exemplary display on the Event Response Confirmation Screen G6 of FIG. 10. This Event Response Confirmation Screen G6 is a screen allowing for confirmation by the user acting as the event organizer creating the event and is a screen used to display the response status at a given moment.

Would-be attendee user images G64, a transition button G65 used for transitioning to the Event Creation Screen G3, and an event option column G66 are displayed on the Event Response Confirmation Screen G6. The candidate location and time of the event are displayed, depending on the number of candidates of the event, in the column direction in the event option column G66. The fields displayed here include an aggregation field G68, where the number of people who responded with “◯”, “Δ”, or “x” is displayed for each respective candidate in the row direction, and a response field G69, where responses for each respondent are displayed.

The event organizer sees the event attendance status, determines which candidate to use, and taps on the event confirm button G67 displayed in the field of the candidate to be used. When the event confirm button G67 is tapped, users who responded that they would attend the confirmed event are notified using a message to that effect. The message is displayed on the chat interface if the user is a registered user. If the user is an unregistered user, the user is notified using a converted communication modality. Alternatively, the user if notified of a URL used to inform about the determined event. It should be noted that notifications can also be sent to users who responded that it was unclear whether they would attend, or could not attend. In such cases, the event organizer can send a notification along with comments, and these comments can be selected from several pre-configured stock phrases.

The present invention has been described above with reference to working examples. The present invention is not limited to the above-described working examples as well as the contents of the working examples and can be implemented in various modifications within the scope of the present invention. The above-described working examples are illustrative and it will be understood by those skilled in the art that numerous variations are possible based on combining these constituent elements and processing procedures, and such variations are within the scope of the present invention.

### INDUSTRIAL APPLICABILITY

A chat service can be initiated in a smooth manner without making users aware of the service registration status of the chat partners.

### REFERENCE NUMERALS

10 server; 12 server receiver unit; 14 chat control unit; 16 server transmitter unit; 20 server memory; 22 registration control unit; 24 selection unit; 26 conversion unit; 30 network; 40 base station; 40a first base station; 40b second base station; 40c third base station; 50 mobile terminal; 50a first mobile terminal; 50b second mobile terminal; 50c third mobile terminal; 52 terminal receiver unit; 54 terminal control unit; 56 terminal transmitter unit; 58 user interface; 60 terminal memory; 62 message management unit; 64 web update unit; 70 PC terminal; 72 chat control unit; 74 chat control unit; 80 event management unit; 100 chat system.

1. A communication method used for the transmission and reception of messages with the help of information processing terminals, wherein the method includes the steps of: receiving a destination and a message to be transmitted to said destination; selecting one communication modality from one or more communication modalities registered in memory in association with the received destination based on information indicating the order of priority of the communication modalities to be employed; and transmitting the message to the destination using the selected communication modality.

2. The communication method according to claim 1, wherein the method includes the steps of: acquiring one or more pieces of contact information stored in an information processing terminal; matching the acquired contact information with registered contact information; and combining the acquired contact information with the registered contact information if, as a result of matching, it is found that common information is contained in the two pieces of contact information.

3. The communication method according to claim 1, wherein the method includes the steps of: if a message based on a communication modality other than chat is received, converting said message to a message in chat format; and displaying the converted message on a chat interface.

4. The communication method according to claim 1, wherein the method includes the steps of: allowing a user to select one or more messages displayed on a chat interface; attaching flags to the selected messages and managing them as messages selected by the user; in response to an instruction from the user, using the flags to extract one or more messages selected by the user in the past; and exporting the extracted messages to a web page and allowing a predetermined user to view them.

5. The communication method according to claim 1, wherein the method includes the steps of: creating event information obtained by combining one of one or more time candidates with one of one or more location candidates, and posing a query as to possible attendance of the event associated with the created event information; and, if the selection step resulted in selecting a communication modality other than chat when the query about possible attendance of the event was posed, including URL information used to receive responses related to possible attendance from users into a message to be transmitted.

6. A non-transitory computer-readable medium including instructions executed by a processor and used by a service performing the transmission and reception of messages with the help of information processing terminals, wherein the instructions executed by the processor comprise: receiving a destination and a message to be transmitted to said destination; selecting one communication modality from one or more communication modalities registered in memory in association with the received destination based on information indicating the order of priority of the communication modalities to be employed; and transmitting the message to the destination using the selected communication modality.

7. A communication apparatus used by a service performing the transmission and reception of messages with the help of information processing terminals, wherein the apparatus is provided with: a reception unit receiving a destination and a message to be transmitted to said destination; a selection unit selecting one communication modality from one or more communication modalities registered in memory in association with the received destination based on information indicating the order of priority of the communication modalities to be employed; and a transmitter unit transmitting the message to the destination using the selected communication modality.
